(19) United States
(12) Patent Application Publication
(10) Pub. No.: US 2025/0092639 A1
(43) Pub. Date: Mar. 20, 2025

(54) CONSTRUCTION VEHICLE WITH MULTI-DRIVE CONFIGURATION

(71) Applicant: DEERE & COMPANY, Moline, IL (US)

(72) Inventors: Nilesh T. Kumbhar, Karad (IN); Brett S. Graham, Dubuque, IA (US); Steven R. Whiteman, Dubuque, IA (US); Trent A. Luoma, Dubuque, IA (US); Sujit Waghmode, Pune (IN)

(21) Appl. No.: 18/469,340

(22) Filed: Sep. 18, 2023

(51) Int. Cl. E02F 9/20; E02F 9/02; E02F 9/08

(52) U.S. Cl. CPC E02F 9/202; E02F 9/02; E02F 9/0866

(57) ABSTRACT

A construction vehicle including a core defining a top, and a bottom opposite the top. The core including a frame, a drive motor coupled to the frame, where the drive motor defines a drive axis, and a drive assembly coupled to the core. The drive assembly including a first load-bearing wheel defining a first axis of rotation, and a second load-bearing wheel defining a second axis of rotation, where together the first axis of rotation and the second axis of rotation define a centerline plane, where the first axis of rotation and the second axis of rotation define an intermediate zone therebetween, where the drive axis is positioned between the centerline plane and the top of the core, and where the drive axis is positioned outside the intermediate zone.

### FIELD

The embodiments described herein related to a skid loader, and more specifically to a skid loader that can be manufactured in both a tracked and a wheeled drive configuration while maintaining a single drive motor position.

### BACKGROUND

Skid loader style construction equipment is typically available in both tracked and wheeled models.

### SUMMARY

In some implementations, a construction vehicle including a core defining a top, a bottom opposite the top, the core including a frame, a drive motor coupled to the frame, where the drive motor defines a drive axis, and a drive assembly coupled to the core, the drive assembly including a first load-bearing wheel defining a first axis of rotation, and a second load-bearing wheel defining a second axis of rotation, where together the first axis of rotation and the second axis of rotation define a centerline plane, and where the first axis of rotation and the second axis of rotation define an intermediate zone therebetween, and where the drive axis is positioned between the centerline plane and the top of the core, and where the drive axis is positioned outside the intermediate zone.

Alternatively or additionally, in any combination, where the first load-bearing wheel and the second load-bearing wheel support a tire thereon.

Alternatively or additionally, in any combination, where the drive assembly further includes a track extending around the first load-bearing wheel and the second load-bearing wheel.

Alternatively or additionally, in any combination, further comprising a power generator configured to provide energy to the drive motor.

Alternatively or additionally, in any combination, where the drive motor includes an output shaft rotatable about the drive axis, and where the construction vehicle further comprises a sprocket attached to the output shaft for rotation together therewith.

Alternatively or additionally, in any combination, where the drive assembly includes at least one of a belt and a chain in operable communication with the sprocket and configured to transmit torque between the drive motor and at least one of the first load-bearing wheel and the second load-bearing wheel.

Alternatively or additionally, in any combination, further comprising a transmission operably positioned between the drive motor and the sprocket.

Alternatively or additionally, in any combination, where the drive assembly includes a housing, and where the housing is configured to transmit loads between the first and second load-bearing wheels and the frame.

Alternatively or additionally, in any combination, where the housing defines a volume therein, and where the volume is at least partially filled with oil.

Alternatively or additionally, in any combination, where the first axis of rotation and the second axis of rotation are movable with respect thereto while remaining parallel to each other.

Alternatively or additionally, in any combination, further comprising a bucket assembly coupled to the core.

Alternatively or additionally, in any combination, where the drive motor is a first drive motor, where the drive axis is a first drive axis, and where the drive assembly is a first drive assembly, the construction vehicle further comprising a second drive motor coupled to the frame that defines a second drive axis, and a second drive assembly coupled to the core.

Alternatively or additionally, in any combination, were the first drive axis is coaxial with the second drive axis.

In another implementation, a construction vehicle including a core including a frame, a drive motor coupled to the frame, where the drive motor defines a drive axis, and a drive assembly mounting point, a bucket assembly coupled to the core, a wheeled drive assembly including a wheel housing, a first wheel rotatably coupled to the wheel housing for rotation with respect thereto, and a first input axis, where the first input axis is aligned with the drive axis when the wheeled drive assembly is coupled to the drive assembly mounting point, and a tracked drive assembly including a track housing, a track wheel rotatable relative to the track housing, a track, and a second input axis, where the second input axis is aligned with the drive axis when the tracked drive assembly is coupled to the drive assembly mounting point.

Alternatively or additionally, in any combination, where the wheeled drive assembly includes an input sprocket, and where the first input sprocket defines the first input axis.

Alternatively or additionally, in any combination, where the tracked drive assembly includes an input sprocket, and where the input sprocket defines the second input axis.

Alternatively or additionally, in any combination, where the wheel housing is couplable to the drive assembly mounting point to convey forces between the first wheel and the frame.

Alternatively or additionally, in any combination, where the track housing is couplable to the drive assembly mounting point to convey forces between the track wheel and the frame.

Alternatively or additionally, in any combination, where the wheeled drive assembly and the tracked drive assembly are interchangeable.

In another implementation, a construction vehicle including a frame defining a frame volume, a drive motor coupled to the frame and at least partially positioned within the frame volume, the drive motor defining a drive axis, a wheel housing defining a housing volume therein, where the housing volume is separate from the frame volume, and where the wheel housing is removably coupled to the frame, a first wheel rotatably mounted to the wheel housing for rotation with respect thereto about a first axis, a second wheel rotatably mounted to the wheel housing for rotation with respect thereto about a second axis.

Alternatively or additionally, in any combination, where the housing volume contains oil therein.

Alternatively or additionally, in any combination, where the wheel housing is coupled to the frame by one or more fasteners.

Alternatively or additionally, in any combination, where the first axis and the second axis define an intermediate volume therebetween, and where the output axis is positioned outside the intermediate volume.

### BRIEF DESCRIPTION OF THE DRAWINGS

FIG. 1 is a rear-perspective view of a construction vehicle in the wheeled configuration.

FIG. 2 is a rear-perspective view of the construction vehicle of FIG. 1 with the bucket assembly removed.

FIG. 3 is a rear-perspective view of the construction vehicle of FIG. 1 in a tracked configuration.

FIG. 4 is a top-perspective view of a frame of the construction vehicle of FIG. 1.

FIG. 5 is a side view of the construction vehicle of FIG. 1 in the wheeled configuration.

FIG. 6 is a detailed exploded view of the wheeled drive assembly of the construction vehicle of FIG. 5.

FIG. 7 is a detailed view of the wheeled drive assembly with the wheels removed for clarity.

FIG. 8 is a side view of the construction vehicle of FIG. 1 in the tracked configuration.

FIG. 9 is a rear-perspective view of the construction vehicle of FIG. 1 in the tracked configuration with the frame made transparent.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect.

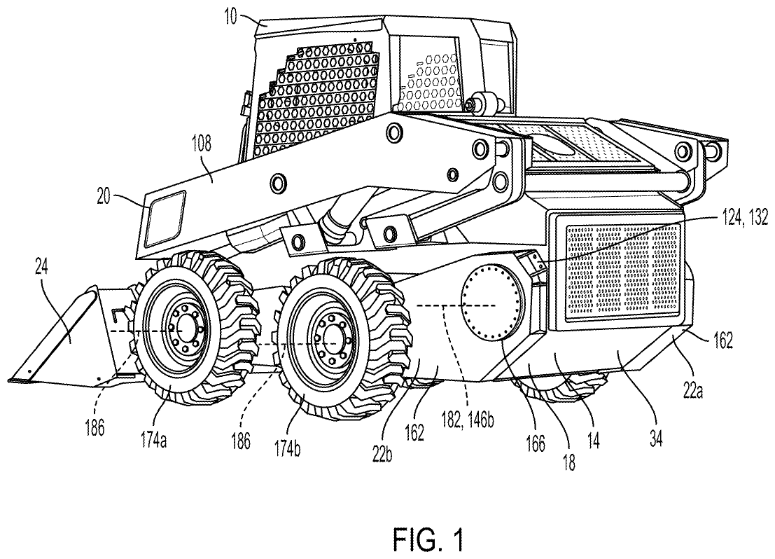

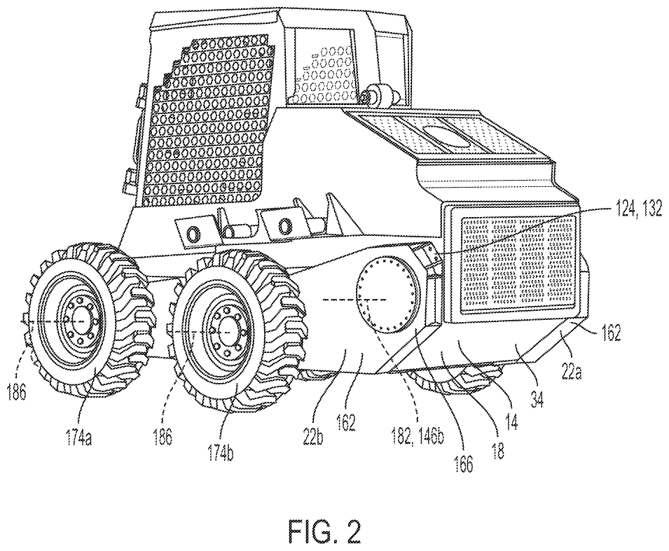

FIGS. 1-9 illustrate a construction vehicle 10 such as a skid-steer loader (SSL) or compact track loader (CTL) that can be manufactured in both a wheeled and tracked variant using a common midframe or core. More specifically, the vehicle 10 is constructed such that a common mainframe or core design can be mated with either a wheeled drive assembly or a tracked drive assembly without having to alter the position of the drive motors contained in the mainframe. Stated differently, the mainframe of the vehicle includes a pair of drive motors (left and right side) installed therein with each motor having a corresponding motor body and output axis. During assembly, the common mainframe can be manufactured in a wheeled configuration (e.g., by attaching a wheeled drive assembly to the mainframe, discussed below) or in a tracked configuration (e.g., by attaching a tracked drive assembly to the mainframe, discussed below) without having to change the location of either drive motor and/or the drive axis with respect to the mainframe.

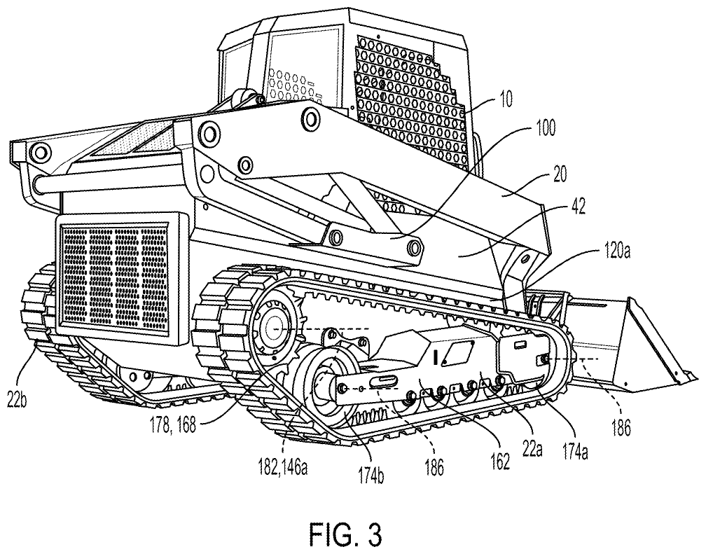

As shown in FIGS. 1 and 3, the vehicle 10 includes a mainframe or core assembly 14, a bucket or other working assembly 20 movably attached to the mainframe 14, and a pair of drive assemblies 22 coupled to the mainframe 14 to support and convey the vehicle 10 across a support surface (e.g., the ground, a road, and the like).

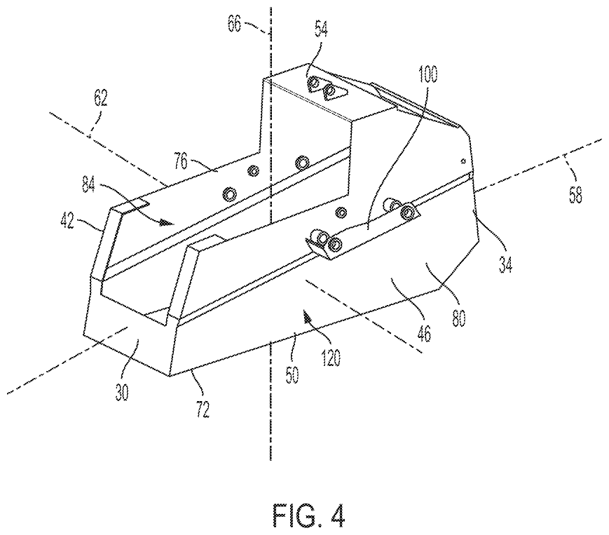

The mainframe 14 of the vehicle 10 includes a frame 18, a power generator 26 mounted within the frame 18, and a pair of drive motors 28. The mainframe 14 also includes a front or first end 30, a second or rear end 34 opposite the first end 30, a first or right side 42, a second or left side 46 opposite the first side 42, a bottom 50, and a top 54 opposite the bottom 50. The mainframe 14 defines a longitudinal axis 58 extending midway between the right side 42 and the left side 46 that passes through the first end 30 and the second end 34 (see FIG. 1). The mainframe 14 also defines a lateral axis 62 oriented perpendicular to the longitudinal axis 58 that passes through the left side 46 and the right side 42, and a vertical axis 66 oriented normal to the longitudinal axis 58 and the lateral axis 62 (see FIG. 4).

The frame 18 of the vehicle 10 includes a series of panels, beams, brackets and the like that are coupled together to form a rigid load-bearing structure. The frame 18 generally includes a base wall 72 forming the bottom 50 of the mainframe 14, a first side wall 76 extending upwardly from the perimeter of the base wall 72 (e.g., corresponding with the right side 42), and a second side wall 80 extending upwardly from the perimeter of the base wall 72 opposite the first side wall 76 (e.g., corresponding to the left side 46, see FIG. 4). Together, the base wall 72, first side wall 76, and second side wall 80 at least partially enclose a tub or frame volume 84 therebetween. The frame 18 may also include additional walls and/or reinforcing members as needed for structural support, rigidity, and assembly.

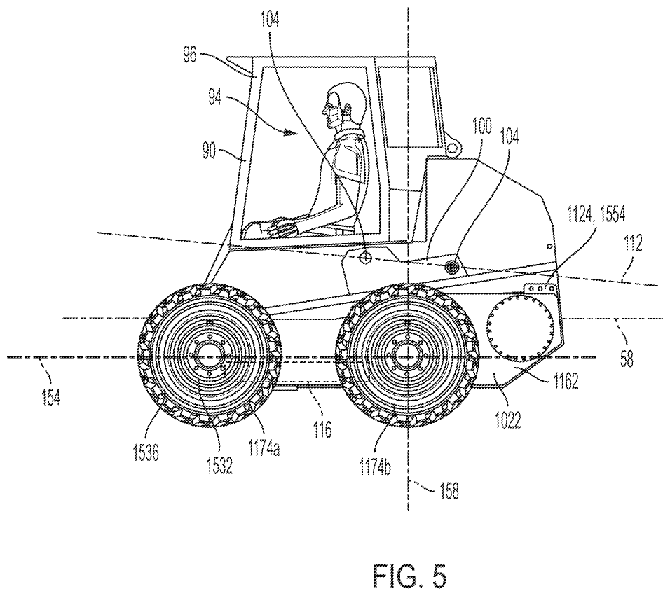

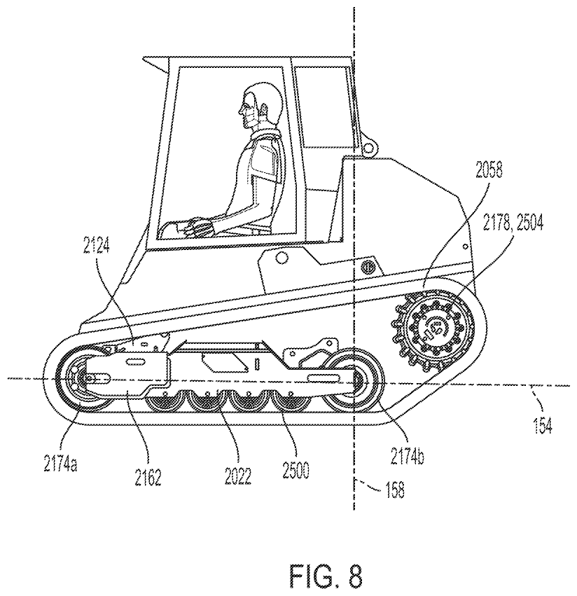

The frame 18 also includes a pair of brackets 100 extending outwardly from the first and second side walls 76, 80. Together, the brackets 100 serve as a mounting location for the bucket or accessory assembly 20. Each bracket 100, in turn, includes a pair of mounting points 104 relatively positioned such that the linkage 108 of the bucket assembly 20 may be pivotably attached thereto (discussed below). In the illustrated embodiment, the mounting points 104 of each bracket 100 are generally positioned along a mounting axis 112 that is perpendicular to the vertical axis 66 (e.g., +5 degrees, +10 degrees, +15 degrees, and +20 degrees) and proximate the longitudinal center of the mainframe 14. More specifically, each bracket 100 is positioned such that it at least partially overlaps with the cab 90 in the longitudinal direction. In some embodiments, the brackets 100 may be positioned such that they at least partially overlap the axis of rotation 186 of the rearmost load-bearing wheel 174b (discussed below) in the longitudinal direction (see FIGS. 5 and 8).

While the illustrated vehicle 10 is shown having a bucket assembly 20 mounted to the brackets 100 with a bucket 24 positioned proximate the first end 30 of the mainframe 14, it is understood that other forms of working accessories may also be attached to the vehicle 10 such as, but not limited to, drilling apparatus, cutting apparatus, and the like.

The mainframe 14 may also include a cab 90. The cab 90, in turn, includes a cab volume 94 in which the user may sit to operate of the vehicle 10 during use. In some embodiments, the cab 90 may be completely enclosed by a roll cage 96 that may or may not be formed integrally with the frame 18. The cab 90 may also include a seat (not shown) or one or more user interfaces (not shown) to allow the user to interact with and control the vehicle 10 during use. As shown in FIGS. 5 and 8, the cab 90 of the present vehicle 10 is positioned proximate the first end 30 of the mainframe 14.

The power generator 26 of the mainframe 14 is configured to provide energy to the drive motors 28 either directly or indirectly during operation. More specifically, the illustrated power generator 26 is an internal combustion engine (ICE) configured to drive either an integrated or separate power generating device such as, but not limited to, an air compressor, a hydraulic pump, an electric generator, and the like. In some embodiments, the power generator 26 may drive a hydraulic pump that, in turn, provides pressurized hydraulic fluid to the drive motors 28 for operation. In still other embodiments, the power generator 26 may drive an electrical generator to provide electrical energy to the drive motors 28 via a battery pack 116. In still other embodiments, the power generator 26 may directly drive the drive motors 28 via a series of linkages and transmissions.

In the illustrated embodiment, the power generator 26 is generally positioned proximate the rear end 34 of the mainframe 14 longitudinally behind the cab 90. The power generator 26 is also positioned as low as possible in the frame 18 (e.g., proximate the bottom 50) to improve the overall weight distribution and lifting capacity of the vehicle 10.

In embodiments where the power generator 26 provides energy via an electric generator, the battery pack 116 may be positioned within the frame volume 84 adjacent the base wall 72. More specifically, the absence of any internal baffling or bracketry to support the drive assemblies 22 in the current frame 18 allows the battery pack 116 to be more optimally positioned within the mainframe 14 itself. As shown in FIG. 5, the battery pack 116 may be positioned such that it is vertically below the cab 90 relative to the vertical axis 66 and at least partially longitudinally overlapping with the cab 90 relative to the longitudinal axis 58.

As shown in FIG. 4, the mainframe 14 also includes one or more drive assembly mounting points 120a, 120b. Each mounting point 120a, 120b, in turn, is configured to permit a respective drive assembly 22 to be removably coupled to the frame 18 while providing all inputs and connection points necessary for operation. More specifically, the mounting points 120a, 120b of the mainframe 14 are configured so that when a drive assembly 22 is attached thereto, any forces applied to the drive assembly 22 (e.g., the weight of the vehicle 10 applied to the wheels 174 and the like) may be transmitted into the frame 18 and any torque produced by the respective drive motor 28a, 28b may be transmitted to the drive assembly 22a, 22b to convey the vehicle 10 across the support surface. Furthermore, each mounting point 120a, 120b is configured so that it properly orients the drive assembly 22 relative to the frame 18 when the drive assembly 22 is attached thereto (e.g., orienting the axes of rotation 186 so they are perpendicular to the longitudinal axis 58 and parallel to the axes of rotation 186 of the drive assembly 22 mounted to the opposite side of the frame 18).

In the illustrated embodiment, the vehicle 10 includes two mounting points 120a, 120b with one mounting point 120a, 120b corresponding to each side of the vehicle 10 (e.g., a first mounting point 120a on the first side wall 76 and a second mounting point 120b on the second side wall 80). This layout allows for two independently driven drive assemblies 22 to be attached to the vehicle 10 for operation. However, in other embodiments more or fewer mounting points 120a, 120b may be present as needed to accommodate the drive layout of a particular vehicle.

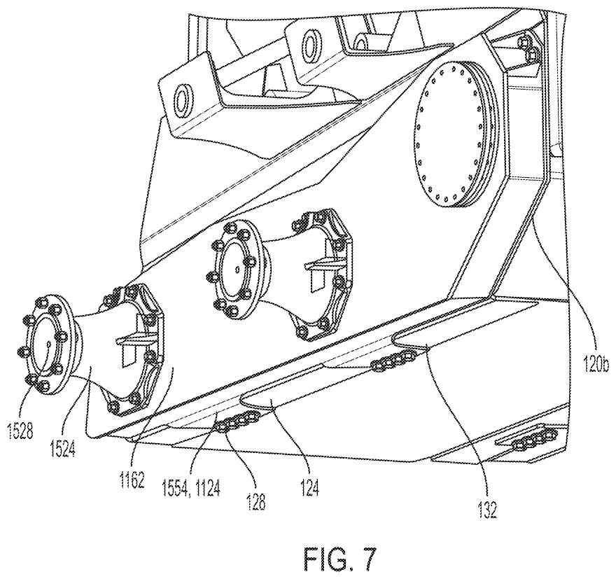

As shown in FIG. 7, each mounting point 120a, 120b includes a series of attachment locations or locking points 124 where the corresponding drive assembly 22 is physically secured to the frame 18. In the illustrated embodiment, the attachment locations 124 include groups of threaded apertures configured to receive a fastener 128 therein. While the current attachment locations 124 use fasteners 128 to secure the drive assembly 22 to the frame 18, in other embodiments different forms of releasable attachment methods may be used such as, but not limited to, interlocking tabs, locking pins, rivets, and the like. In still other embodiments, the attachment points 124 may accommodate more permanent attachment methods such as welding, adhesives, and the like.

In the illustrated embodiment, each attachment location 124 of each mounting point 120a, 120b is positioned so that it corresponds with a respective attachment location 1124, 2124 on both the wheeled drive assembly 1022 and the tracked drive assembly 2022. However, in other embodiments, only a portion of the attachment points 124 may align with the attachment locations 1124, 2124 of both the wheeled and tracked drive assemblies 1022, 2022. In still other embodiments, each mounting point 120a, 120b may have multiple sets of attachment locations 124, with each set corresponding with a particular drive assembly or accessory (e.g., a first set of attachment locations for the wheeled drive assembly and a second set of attachment locations for the tracked drive assembly).

Each mounting point 120a, 120b also includes at least one locating element 132 to help orient and position the drive assembly 22 relative to the frame 18 when attached thereto. In the illustrated embodiment the locating elements 132 includes the outer surfaces of the side walls 76, 80 and base wall 72. In other embodiments, different forms of locating elements 132 may be used such as, but not limited to, locating pins, channels, slots, and the like. In still other embodiments, at least a portion of the locating elements 132 may be integrated into the attachment locations 124 by using the fasteners 128 to at least partially locate the drive assembly 22 relative to the frame 18.

Each mounting point 120a, 120b also includes a drive coupling 136 to serve as an interface where the output shaft 142a, 142b of the drive motors 28a, 28b may be operatively coupled to a corresponding drive assembly 22. More specifically, each drive coupling 136 is configured so that it may be placed in operable communication with either the wheeled and tracked drive assemblies 22a, 22b without modifying the location of the drive motors 28a, 28b. In still other embodiments, the drive coupling 136 itself may be able to be placed in operable communication with either the wheeled and tracked drive assemblies 22a, 22b without modification or relocation.

In the illustrated embodiment, each drive coupling 136 includes an aperture or portal providing direct access to the output shaft 142a, 142b of the corresponding drive motor 28a, 28b. However, in other embodiments the drive coupling 136 may include an intermediate member (not shown) configured to operatively extend between the drive motor 28a, 28b and the drive assembly 22. In such embodiments, the drive coupling 136 may provide some form of universal attachment point that is configured for operational attachment to both a wheeled and tracked drive assembly 22a, 22b.

In still other embodiments, the drive coupling 136 may serve as an adapter extending between the single output shaft 142a, 142b of the drive motor 28a, 28b and the input (discussed below) of the various drive assembly embodiments 22. In such embodiments, a different drive coupling 136 may be used to accommodate the operative connection between the drive motor 28a, 28b and the various drive assembly embodiments 22. For example, in some embodiments the drive coupling 136 may include a gearbox having a pre-determined gear ratio formed therein that is specific to the type of drive assembly being installed (e.g., a first gear ratio for a wheeled drive assembly and a second gear ratio different from the first gear ratio for a tracked drive assembly). In such embodiments, the size and shape of the drive coupling 136 may change to accommodate the layout of each type of drive assembly 22. In still other embodiments, the drive coupling 136 may be adjustable to accommodate different drive assemblies 22. For example, the drive coupling 136 may be configurable to form different gear ratios within a single housing, adjust the location of the output relative to the rotational axis of the drive motor 28a, 28b, and the like.

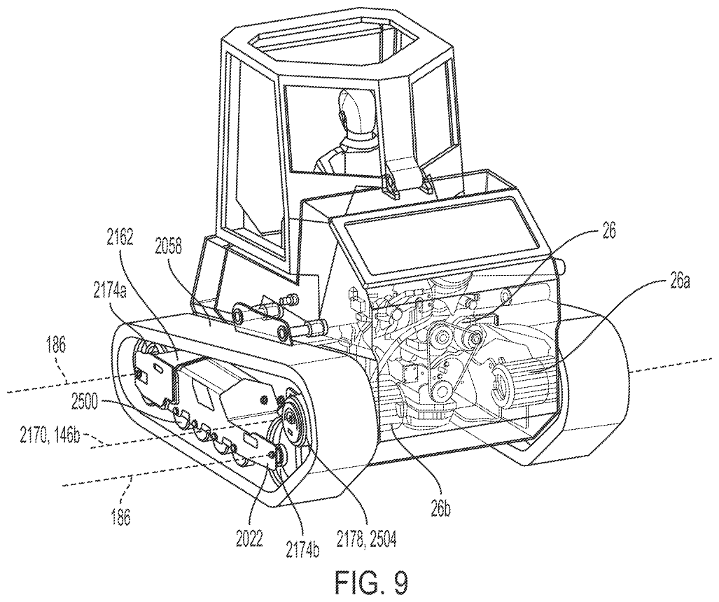

As shown in FIG. 9, the mainframe 14 includes two drive motors 28a, 28b each configured to drive a corresponding drive assembly 22a, 22b and operable independently of each other. More specifically, the first drive motor 28a is generally associated with the drive assembly 22a attached to the first or right side 42 of the vehicle 10 (e.g., via the drive coupling 136 of the first mounting point 120a) while the second drive motor 28b is generally associated with the drive assembly 22b attached to the second or left side 46 of the vehicle 10 (e.g., via the drive coupling 136 of the second mounting point 120b). As is known for SSLs and CTLs, the independent operation of the first drive motor 28a and second drive motor 28b allows the user to maneuver the vehicle 10 over the support surface.

Each drive motor 28a, 28b includes an output shaft 142a, 142b defining an output axis 146a, 146b, and a motor housing 150a, 150b fixed relative to the frame 18. During operation, the output shaft 142a, 142b of each motor 28a, 28b rotates relative to the housing 150a, 150b generating torque that is subsequently directed to the drive assembly 22a, 22b associated therewith.

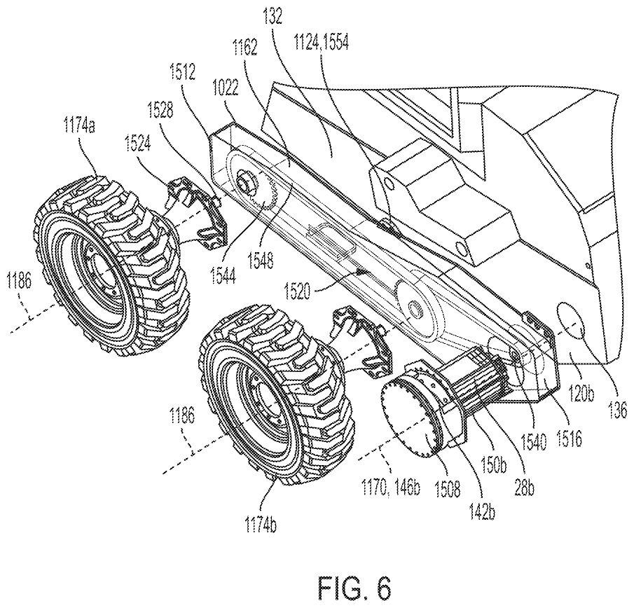

As shown in FIGS. 6-9, each drive motor 28a, 28b is positioned such that its corresponding output axis 146a, 146b is oriented parallel to the lateral axis 62 and positioned proximate the second end 34 of the mainframe 14. More specifically, the output axes 146a, 146b are positioned rearward of at least a portion of the engine 26 and rearward of the cab 90. In some embodiments, the output axis 146a, 146b of both drive motors 28a, 28b are positioned rearward of the entire engine 26 and rearward of the entire cab 90. In still other embodiments, the output axis 146a, 146b of both drive motors 28a, 28b are positioned rearward of the brackets 100. Taken relative to the drive assembly 22 to which the drive motors 28a, 28b are operatively associated, the output axis 146a, 146b of both drive motors 28a, 28b are positioned above the centerline plane 154 (e.g., between the centerline plane 165 and the top 54, described below), and rearward of the rear-datum 158 (e.g., between the rear datum 158 and the second end 34, described below).

As shown in FIGS. 1-9, once assembled the vehicle 10 includes a pair of drive assemblies 22a, 22b attached to the mainframe 14 that together are configured to convey the vehicle 10 over a support surface. More specifically, the vehicle 10 includes a first drive assembly 22a attached to the right side 42 of the frame 18 via the first mounting point 120a and a second drive assembly 22b attached to the left side 46 of the frame 18 via the second mounting point 120b. During use, the first drive assembly 22a is driven by the first drive motor 28a while the second drive assembly 22b is driven by the second drive motor 28b independently of the first drive assembly 22a.

Each drive assembly 22 includes a drive housing 162 fixedly coupled to the frame 18, an input member 166 defining an input axis 182, and one or more load-bearing wheels 174 coupled to the drive house 162 for rotation with respect thereto. In the illustrated embodiments, the input member 166 includes a sprocket 178 mounted for rotation about the input axis 182. When installed, the sprocket 178 is operatively coupled to and driven by the drive motor 28a, 28b. The input axis 182 is also co-axial with the output axis 146. While the illustrated input member 166 is a sprocket 178, it is understood that other forms of input member 166 may also be present such as, but not limited to, a shaft, a pulley, and the like.

The load-bearing wheels 174 of the drive assembly 22 generally includes any wheel that is intended to bear at least a portion of the weight of the vehicle 10 on the support surface. Each wheel 174, in turn, defines an axis of rotation 186 about which it rotates during use. As shown in FIGS. 5 and 8, the drive assemblies 22 include a forward-most load-bearing wheel 174a (e.g., the load-bearing wheel 174 positioned closest to the first end 30), and a rearward-most load-bearing wheel 174b (e.g., the load-bearing wheel 174 positioned closest to the second end 34). The drive assembly 22 may also include one or more load bearing wheels therebetween.

Together, the axes of rotation 186 of the forward-most load-bearing wheel 174a and the rearward-most load-bearing wheel 174b form a centerline plane 190. The axis of rotation 186 of the rearward-most load-bearing wheel 174b also defines a rear-datum 194 passing therethrough and oriented parallel to the vertical axis 66 (see FIGS. 5 and 8).

As shown in FIGS. 5-7, in some embodiments the drive assembly 22 may include a wheeled drive assembly 1022. The wheeled drive assembly 1022 includes a wheeled housing 1162, a forward load-bearing wheel 1174a, a rearward load-bearing wheel 1174b, and an input assembly 1508.

The wheeled housing 1162 of the wheeled drive assembly 1022 includes an elongated body having a first end 1512 proximate the first end 30 of the mainframe 14, and a second end 1516 opposite the first end 1512 proximate the second end 34 of the mainframe 14. The wheeled housing 1162 is also substantially hollow defining a housing volume 1520 therein. In the illustrated embodiment, the wheeled housing 1162 has a length and shape that generally corresponds with the length and shape of the bottom 50 of 136 mainframe 14. Furthermore, the size and shape of the wheeled housing 1162 is such that the housing 1162 at least partially overlaps with the drive coupling 136 of the mounting point 120a, 120b. When installed, the wheeled housing 1162 is configured to be fixedly coupled to a respective mounting point 120 on the mainframe 14 to transmit forces between the wheels 1174a-b and the frame 18.

In the illustrated embodiment, the wheeled housing 1162 is formed fluid-tight such that a volume of oil or other lubricant can be placed in the volume 1520 to lubricate the components contained therein. In the illustrated embodiment, the volume 1520 is fluidly isolated from the frame volume 84 aside from the connection at the drive coupling 136. Although not shown, the wheeled housing 1162 may also include fill and drain ports to allow the lubricant to be poured into and drained out of the volume 1520 during use.

The wheeled housing 1162 also includes a plurality of attachment locations 1124 each configured to correspond with an attachment location 124 of the mounting points 120a, 120b of the mainframe 14. More specifically, the illustrated housing 1162 includes a series of plates defining apertures therein that are configured to align with the corresponding apertures of the mounting points 120a, 120b to allow a fastener 128 to fixedly secure the housing 1162 in place. While the illustrated attachment locations 1124 include plates with apertures formed therein, it is understood that other forms of attachment both releasable and permanent in nature may also be used.

The wheeled housing 1162 also includes at least one location element 1554 that corresponds with the location element 132 of the mounting points 120a, 120b. In the illustrated embodiment, the location element 1554 includes the exterior surfaces of the housing 1162, however in other embodiments different forms of location element 1554 such as pins, channels, grooves, and the like may be used. In still other embodiments, the location elements 1554 of the may be at least partially incorporated into the attachment locations 1124.

The wheeled housing 1162 also includes a plurality of wheel supports 1524, each extending laterally outwardly from the wheeled housing 1162 and configured to rotationally support a corresponding wheel hub or axle 1528. More specifically, each wheel support 1524 includes housing with a series of bearings included therein that supports the wheel hub 1528 for rotation about a corresponding axis of rotation 1186. In the illustrated embodiment, the wheeled housing 1162 includes one wheel support 1524 for each load-bearing wheel 1174a-b. Furthermore, in the illustrated embodiment each wheel support 1524 is formed separately from the housing 1162 and coupled thereto. However, in other embodiments the wheel supports 1524 may be integrally formed with the housing 1162.

Both the forward load-bearing wheel 1174a and the rearward load-bearing wheel 1174b include a hub 1532 configured for attachment to a corresponding wheel hub 1528 and a pneumatic tire 1536 mounted to the hub 1528. When assembled, each wheel 1174a-b is mounted to a respective hub 1528 for rotation about the corresponding axis of rotation 1186. It is understood that in other embodiments, different forms of wheel, such as solid rubber wheels, omni-directional wheels, foam wheels, and the like may also be used.

The input assembly 1508 of the wheeled drive assembly 1022 is configured to receive torque from the output shaft 142 of the drive motor 28 and convey the torque to both the forward wheel 1174a and the rearward wheel 1174b. More specifically, the input assembly 1508 is configured to transmit the torque to both the forward wheel 1174a and the rearward wheel 1174b such that both wheels 1174a-b rotate in the same direction and at the same speed.

The input assembly 1508 includes an input sprocket 1540, a plurality of drive sprockets 1544 each fixedly attached to a respective hub 1528 for rotation together therewith, and one or more chains or belts 1548 to convey the forces therebetween. In the illustrated embodiment, all of the drive sprockets 1544 are the same size so that all of the hubs 1528 rotate at the same speed.

When the drive assembly 2022 is installed on the mainframe 14, the input sprocket 1540 of the drive assembly 2022 is configured to be placed in operable communication with the output shaft 142 of the appropriate drive motor 28a, 28b to receive torque therefrom. More specifically, the sprocket 1540 may be mounted to the output shaft 142 of a corresponding drive motor 28 such that the input axis 1170 and the output axis 146 are co-axial. In the illustrated embodiment, the sprocket 1540 is mounted directly to the output shaft 142 such that the two elements rotate together as a unit. However, in other embodiments the sprocket 1540 may be indirectly mounted to the output shaft 142 (e.g., via a gearbox and the like) such that the sprocket 1540 may rotate at a different speed than the output shaft 142.

During use, torque is applied by the drive motor 28 to rotate the sprocket 1540. The sprocket 1540, in turn, applies the torque to the drive sprockets 1544 by way of the intervening belts and chains 1548. By doing so, the rotation of the sprocket 1540 is transmitted to both wheels 1174a-b causing both wheels 1174a-b to rotate in the same direction at the same speed.

To manufacture or assemble a vehicle 10 in a wheeled configuration, the user first begins with the common core or mainframe 14 as described above. With the mainframe 14 procured, the user may then secure a wheeled drive assembly 1022. With the parts obtained, the user may then align the wheeled drive assembly 1022 relative to the first drive assembly mounting point 120a. To do so, the user aligns the attachment locations 124 of the mounting point 120a with the attachment locations 1124 of the housing 1162. Furthermore, the user aligns the input axis 1170 of the wheeled drive assembly 1022 with the output axis 146a of the drive motor 28a.

With the wheeled drive assembly 1022 aligned, the user may position the wheeled drive assembly 1022 by moving it laterally inwardly toward the mainframe 14 until the alignment elements 1554 of the wheeled housing 1162 come in contact with and align relative to the alignment elements 132 of the mounting point 120a. Once in place, the user may then fix the housing 1162 in place by installing all of the necessary fasteners 128.

While moving the drive assembly 1022 laterally inwardly, the user also makes sure to align and couple the output shaft 142a of the drive motor 28a to the input sprocket 1540 of the drive assembly 1022 either directly or indirectly via the drive coupling 136. In some embodiments, the drive coupling 136 may be configured so that the operable connection between the output shaft 142a and the input sprocket 1540 may be made after the housing 1162 is in place.

With the drive assembly 1022 in place, the user can then fill the housing volume 1520 with oil or other lubricants as required. The same process may then be duplicated on the opposite side of the vehicle 10 using the second mounting point 120b, second drive motor 28b, and the second output shaft 142b.

As shown in FIGS. 8-9, in some embodiments the drive assembly may include a tracked drive assembly 2022. The tracked drive assembly 2022 includes a tracked housing 2162, a forward load-bearing wheel 2174a rotatable relative to the tracked housing 2162, a rearward load-bearing wheel 2174b rotatable relative to the tracked housing 2162, and a plurality of idler wheels 2500 each rotatable relative to the tracked housing 2162 and positioned between the forward and rearward load-bearing wheels 2174a-b. The tracked drive assembly 2022 also includes an input assembly 2504, and a track 2058.

The input assembly 2504 of the tracked drive assembly 2022 includes a sprocket 2178 that is configured to rotate about an input axis 2170. When assembled, the sprocket 2178 is mounted to the output shaft 142 of a corresponding drive motor 28 such that the input axis 2170 and the output axis 146 are co-axial. In the illustrated embodiment, the sprocket 2178 is mounted directly to the output shaft 142 such that the two elements rotate together as a unit. However, in other embodiments the sprocket 2178 may be indirectly mounted to the output shaft 142 (e.g., via a gearbox and the like) such that the sprocket 2178 may rotate at a different speed than the output shaft 142.

The track 2058 of the tracked drive assembly 2022 forms a continuous loop extending about the sprocket 2178, the forward wheel 2174a, the rearward wheel 2174b, and all of the idler wheels 2500. During operation, the drive motor 28a, 28b generates torque that rotates the sprocket 2178. The sprocket 2178, in turn, applies a force to the track 2058 causing it to circulate about its path around the forward load-bearing wheel 2174a, the rearward load-bearing wheel 2174b, and the idler wheels 2500.

To manufacture or assemble a vehicle 10 in a tracked configuration, the user first begins with the common core or mainframe 14 as described above. With the mainframe 14 procured, the user may then secure a tracked drive assembly 2022. With the parts obtained, the user may then align the tracked housing 2162 relative to the first drive assembly mounting point 120a. To do so, the user aligns the attachment locations 124 of the mounting point 120a with the attachment locations 2124 of the housing 2162.

With the tracked drive assembly 2022 aligned, the user may position the tracked drive assembly 2022 by moving the housing 2162 laterally inwardly toward the mainframe 14 until the alignment elements 2124 of the tracked housing 2162 come in contact with and align relative to the alignment elements 132 of the mounting point 120a. Once in place, the user may then fix the housing 2162 in place by installing all of the necessary fasteners 128.

With the housing 2162 in place, the user may then separately install the input assembly 2504 or sprocket 2178 to the output shaft 142a of the drive motor 28a either directly or indirectly via the drive coupling 136.

With the input assembly 2504 in place, the user can then route the track 2058. This process may include adjusting the positions of one of the wheels 2174a-b relative to the housing 2162 to increase and decrease the tension on the track 2058 as necessary. With the track installed 2058, the same process may then be duplicated on the opposite side of the vehicle 10 using the second mounting point 120b, second drive motor 28b, and the second output shaft 142b.

Although aspects of the disclosure have been described in detail with reference to certain preferred embodiments, variations and modifications exist within the scope and spirit of one or more independent aspects as described.

1. A construction vehicle comprising:
a core defining a top, a bottom opposite the top, the core including:
a frame,
a drive motor coupled to the frame, wherein the drive motor defines a drive axis, and
a drive assembly coupled to the core, the drive assembly including:
a first load-bearing wheel defining a first axis of rotation, and
a second load-bearing wheel defining a second axis of rotation, wherein together the first axis of rotation and the second axis of rotation define a centerline plane, and wherein the first axis of rotation and the second axis of rotation define an intermediate zone therebetween; and
wherein the drive axis is positioned between the centerline plane and the top of the core, and wherein the drive axis is positioned outside the intermediate zone.

2. The construction vehicle of claim 1, wherein the first load-bearing wheel and the second load-bearing wheel support a tire thereon.

3. The construction vehicle of claim 1, wherein the drive assembly further includes a track extending around the first load-bearing wheel and the second load-bearing wheel.

4. The construction vehicle of claim 1, further comprising a power generator configured to provide energy to the drive motor.

5. The construction vehicle of claim 1, wherein the drive motor includes an output shaft rotatable about the drive axis, and wherein the construction vehicle further comprises a sprocket attached to the output shaft for rotation together therewith.

6. The construction vehicle of claim 5, wherein the drive assembly includes at least one of a belt and a chain in operable communication with the sprocket and configured to transmit torque between the drive motor and at least one of the first load-bearing wheel and the second load-bearing wheel.

7. The construction vehicle of claim 5, further comprising a transmission operably positioned between the drive motor and the sprocket.

8. The construction vehicle of claim 1, wherein the drive assembly includes a housing, and wherein the housing is configured to transmit loads between the first and second load-bearing wheels and the frame.

9. The construction vehicle of claim 8, wherein the housing defines a volume therein, and wherein the volume is at least partially filled with oil.

10. The construction vehicle of claim 1, wherein the first axis of rotation and the second axis of rotation are movable with respect thereto while remaining parallel to each other.

11. The construction vehicle of claim 1, further comprising a bucket assembly coupled to the core.

12. The construction vehicle of claim 1, wherein the drive motor is a first drive motor, wherein the drive axis is a first drive axis, and wherein the drive assembly is a first drive assembly,
the construction vehicle further comprising a second drive motor coupled to the frame that defines a second drive axis, and a second drive assembly coupled to the core.

13. The construction vehicle of claim 12, wherein the first drive axis is coaxial with the second drive axis.

14. A construction vehicle comprising:
a core including:
a frame,
a drive motor coupled to the frame, wherein the drive motor defines a drive axis, and
a drive assembly mounting point;
a bucket assembly coupled to the core;
a wheeled drive assembly including:
a wheel housing,
a first wheel rotatably coupled to the wheel housing for rotation with respect thereto, and
a first input axis, wherein the first input axis is aligned with the drive axis when the wheeled drive assembly is coupled to the drive assembly mounting point; and
a tracked drive assembly including:
a track housing,
a track wheel rotatable relative to the track housing,
a track, and
a second input axis, wherein the second input axis is aligned with the drive axis when the tracked drive assembly is coupled to the drive assembly mounting point.

15. The construction vehicle of claim 14, wherein the wheeled drive assembly includes an input sprocket, and wherein the first input sprocket defines the first input axis.

16. The construction vehicle of claim 14, wherein the tracked drive assembly includes an input sprocket, and wherein the input sprocket defines the second input axis.

17. The construction vehicle of claim 14, wherein the wheel housing is couplable to the drive assembly mounting point to convey forces between the first wheel and the frame.

18. The construction vehicle of claim 14, wherein the track housing is couplable to the drive assembly mounting point to convey forces between the track wheel and the frame.

19. The construction vehicle of claim 14, wherein the wheeled drive assembly and the tracked drive assembly are interchangeable.

20. A construction vehicle comprising:
a frame defining a frame volume;
a drive motor coupled to the frame and at least partially positioned within the frame volume, the drive motor defining a drive axis;
a wheel housing defining a housing volume therein, wherein the housing volume is separate from the frame volume, and wherein the wheel housing is removably coupled to the frame;
a first wheel rotatably mounted to the wheel housing for rotation with respect thereto about a first axis,
a second wheel rotatably mounted to the wheel housing for rotation with respect thereto about a second axis.

21. The construction vehicle of claim 20, wherein the housing volume contains oil therein.

22. The construction vehicle of claim 20, wherein the wheel housing is coupled to the frame by one or more fasteners.

23. The construction vehicle of claim 20, wherein the first axis and the second axis define an intermediate volume therebetween, and wherein the output axis is positioned outside the intermediate volume.
